(19) United States
(12) Patent Application Publication
(10) Pub. No.: US 2018/0220725 A1
(43) Pub. Date: Aug. 9, 2018

(54) WEARABLE ELECTRONICS ACCESSORY

(71) Applicant: ONvocal, Inc., Saugus, MA (US)

(72) Inventor: William Wang Graylin, Winchester, MA (US)

(73) Assignee: ONvocal, Inc., Saugus, MA (US)

(21) Appl. No.: 15/427,468

(22) Filed: Feb. 8, 2017

(51) Int. Cl. A41D 27/20; A41D 23/00; A41D 25/00

(52) U.S. Cl. CPC A41D 27/205; A41D 23/00; A41D 25/00; H04R 1/105; A41D 2400/34; H04R 2420/07; A41D 2400/36

(57) ABSTRACT

A wearable electronics fabric accessory for a wearable electronic device such as headphones, headsets, AR/VR devices, a method of using the wearable accessory, and a method of making the wearable accessory are described. The wearable accessory includes fabric that can be wrapped around or fit onto, part of or all of, the electronic support structure of the wearable electronic device, to enclose part or all of the electronic components and structure. The wearable electronics fabric accessory can include an elongated pocket or channel having first and second ends. The elongated pocket includes a first aperture through which wires and earbuds of the wearable electronic device may extend. The elongated pocket also includes a second aperture located at the first end of the elongated pocket. The second aperture allows a first end of a support structure of the wearable device to extend there through. The elongated pocket may further include a third aperture located at the second end of the elongated pocket. The third aperture allows a second end of the support structure of the wearable device to extend there through.

### BACKGROUND

Wireless wearable electronic devices have become increasingly popular. These wireless wearable devices can be used as simple headphones for music, to headsets for music, calls and voice command, and to headsets to include even Augmented Reality and Virtual Reality (AR/VR). These wearables can contain electronics, batteries, speakers, earbuds, microphones, various bio sensors from heartrate to oxygen level, buttons, ports for charging and connections, and even extensions to eye glasses with optical displays. Traditional wireless wearable devices like Bluetooth headphones would fit directly on or in a user's ear, or they would hang over the head and on to the ears, or wrapped behind the head and into the ears, or around the neck with wired earbuds to the ears. The weight and form factor of the electronics often result in discomfort from prolonged use, and most are not suitable to be worn all day as a true “wearable” product should be, nor suitable for physical activities like hurrying through airports and train stations, or working out, because they are susceptible to damage from falling off the ear, head or neck, or contact with sweat. Furthermore, most of these wearable electronic devices around one's neck or head are not considered attractive for those who are fashion conscious to want to wear them in public or in business meetings.

No accessories are available that can properly house the weight and electronics (“support structure”) of these wearable devices to be worn comfortably all day, be secure so it does not shift or fall off, be hygienic and washable, and be fashionable to express the styles of the users while making the electronics as discrete as the users want.

### SUMMARY

The most comfortable place for the electronics support structure of the wearable headsets to rest for prolong periods of time is around the neck. The present disclosure provides a wearable fabric accessory for a wired or wireless wearable headphone, headset or AR/VR device that provides a secure comfortable fit, with hygienic and fashionable style via fabric in the form of a scarf, bandanna, or tie like garments. The wearable accessory includes fabric that can be wrapped around or fit onto, part of or all of, the electronic support structure of the wearable device. The wearable accessory includes an elongated pocket or channel. The fabric can be made of various materials, from simple cotton, silk, nylon, to nanotechnology based fabric that can be anti-odor and/or antibacterial. The fabric can be in the form of a scarf, a bandanna, a neck tie, and can have at least one elongated pocket that can include a first end and a second end, and a first aperture through which the body and wired peripherals of the wearable device may extend. The elongated pocket also includes a second aperture located at the first end of the elongated pocket. The second aperture allows a first end of a support structure of the wearable device to extend there through. The elongated pocket further includes a third aperture located at the second end of the elongated pocket. The third aperture allows a second end of the support structure of the wearable device to extend there through.

The present disclosure also provides a method using the wearable accessory with a wearable device. A first end of the support structure of the wearable device is inserted into the elongated pocket. The support structure is then maneuvered, e.g. slid, through the elongated pocket until a desired amount of the ends of the support structure extend from the elongated pocket. Wires of the wearable device are also extended from the elongated pocket.

The present disclosure further provides a method for making the wearable accessory. A material is cut to produce a desired shape. Two elongated portions of the material are maneuvered and fastened to create the elongated pocket. For example, elongated edges of the elongated portions may be coupled together using stitches. Alternatively, stitches may be used to couple the elongated portions to an opposing elongated surface. The apertures through which parts of the wearable device can extend are also created.

### BRIEF DESCRIPTION OF THE DRAWINGS

For a more complete understanding of the present disclosure, reference is now made to the following description taken in conjunction with the accompanying drawings.

FIG. 1 is a front elevation view of an illustrative wearable device.

FIG. 2 illustrates a user wearing a wearable accessory housing at least a portion of a wearable device according to embodiments of the present disclosure.

FIG. 3 illustrates the wearable accessory housing at least a portion of a wearable device according to embodiments of the present disclosure.

FIG. 4 illustrates a first planar side view of the wearable accessory according to embodiments of the present disclosure.

FIG. 5 illustrates a second planar side view of the wearable accessory according to embodiments of the present disclosure.

FIG. 6 is a process flow diagram illustrating a method for inserting a wearable device into the wearable accessory according to embodiments of the present disclosure.

FIG. 7 is a process flow diagram illustrating a method for making the wearable device according to embodiments of the present disclosure.

FIG. 8 illustrates an alternative embodiment wherein the wearable fabric accessory has a single aperture that a portion of the wearable device extends through and the fabric is wrapped around the support structure for fastening into place at or near an end of the wearable electronic device.

### DETAILED DESCRIPTION

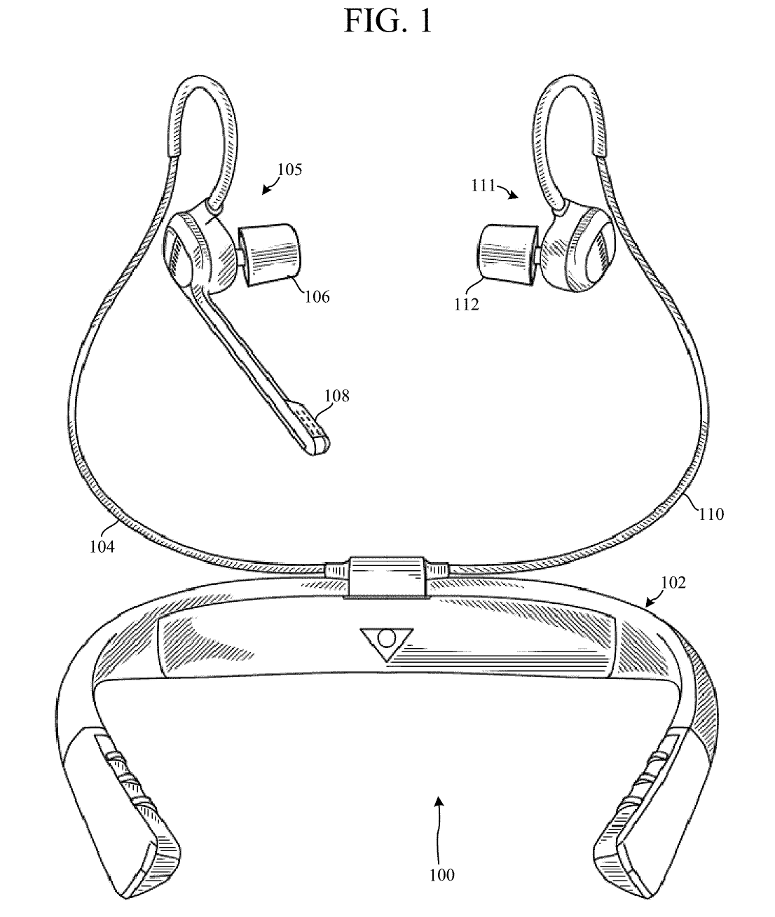

FIG. 1 illustrates a wearable device 100 including a support structure 102. In this implementation, the wearable electronic device is a wearable wireless electronic headset and voice command device. The support structure 102 may be worn at least partially around a user's neck, and may rest on the shoulders and/or collar bone of the user. The support structure 102 may be arcuate.

The support structure 102 may include batteries used to power the wearable device 100, as well as memory and processing components of the wearable device 100. The support structure 102 may further include input/output interfaces that enable the wearable device 100 to wirelessly pair to and communicate with a computing device (either portable or stationary). Such wireless pairing and communication may involve Bluetooth or like transmissions.

A first wire 104 may extend from the support structure 102 to a first ear portion 105 including a first speaker 106 and a microphone 108. A second wire 110 may extend from the support structure 102 to a second ear portion 111 including a second speaker 112.

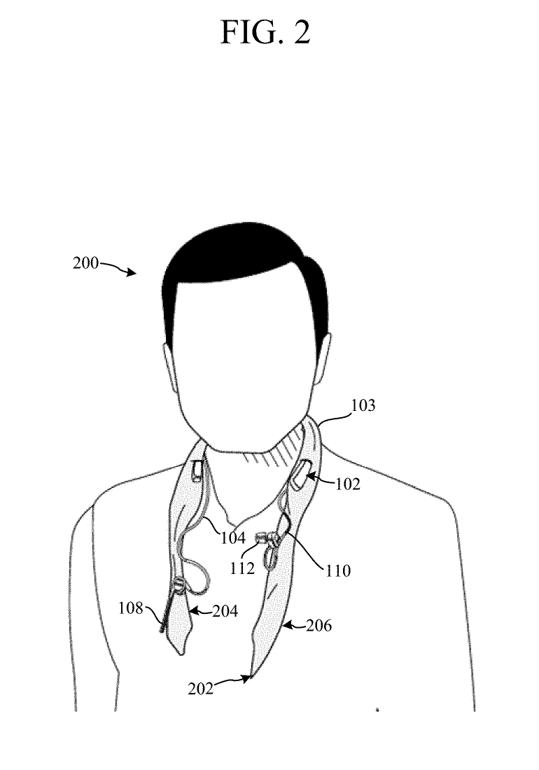

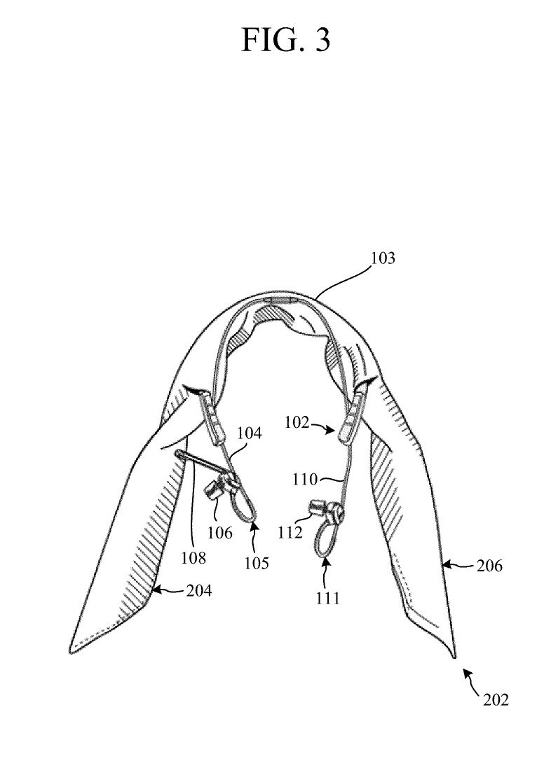

FIG. 2 illustrates a user 200 wearing the wearable device 100. FIGS. 2 and 3 illustrate a wearable accessory 202 used in conjunction with the wearable device 100. The wearable accessory may take the form of a neck tie, scarf, bandana, or other neck accessory. Further, it should be appreciated that the wearable accessory may be configured as a piece of fabric that can be used as a bandanna, a scarf or a tie that can be worn around the head or torso.

The wearable accessory 202 may include an elongated pocket or channel 103 that partially or fully covers the support structure 102. For example, one or more end portions of the support structure 102 may extend from the wearable accessory 202 while the wearable accessory 202 covers an interior or middle portion of the support structure 102 within the elongated pocket 103. The portions of the support structure 102 extending outwardly from the elongated pocket 103 of the wearable accessory 202 may, combined, be smaller in volume than the portion of the support structure 102 covered within the elongated pocket of the wearable accessory 202. That is, the elongated pocket 103 encompasses all but the end portions of the support structure 102 extending from the wearable accessory 202.

As illustrated in FIG. 2, the wires 104, 110 may extend from the wearable accessory 202. In an example, a portion of the support structure 102 to which the wires 104, 110 couple may extend from the wearable accessory 202. Alternatively, only portions of the wires 104, 110 may extend from the wearable accessory 202, i.e., a portion of the support structure 102 to which the wires 104, 110 couple may be covered by the wearable accessory 202. Furthermore, an entirety of one of the wires 104, 110 may entirely extend from the wearable accessory 202 while the other wire may only have a portion thereof extending from the wearable accessory 202. The wires 104, 110 may extend from the wearable accessory 202 at the same locations that the end portions of the support structure 102 extend from the wearable accessory 202. Alternatively, the wires 104, 110 may extend from the wearable accessory 202 at one or more different locations than the end portions of the support structure 102.

If the wearable accessory 202 fully covers the support structure 102, i.e., if the pocket of the wearable accessory 202 has a length commensurate in scope with or larger than a circumferential length of the support structure 102, it should be appreciated that only the wires 104, 110, the speakers 106, 112, and the microphone 108 may extend from the wearable accessory. Regardless of whether the wearable accessory 202 partially or fully covers the support structure 102, the wires 104, 110, the speakers 106, 112, and the microphone 108 should extend from the wearable accessory 202.

The wearable accessory 202 may include a first end portion 204 and a second end portion 206. The first and second end portions 204, 206 may be tied together, clasped together, or frictionally held in place by clothing of the user, such as a jacket. The first and second end portions 204, 206 may be tied, clasped, fastened, secured, etc. to stabilize the support structure 102 around the neck of the user 200. The first and second end portions 204, 205 may be of varying lengths as a function of style or size of the wearable accessory.

The wearable accessory 202 may be designed of various materials based on comfort considerations of the material to the user and fashion or style considerations of the material. The material of the wearable accessory 202 may also be chosen based on hygiene considerations. For example, a material capable of soaking up sweat of the user 200, and capable of being washed, may be chosen. Materials may include different types of cotton, silk, nylon, synthetic antibacterial material (such as Green Shield+Balance Barrier materials available from Brentano of Wheeling, Ill., U.S.A.: http://www.brentanofabrics.com/crypton/default.aspx?type=greenshield), nano technology material (such as Nano-Tex+BioAm materials available from Brentano of Wheeling, Ill., U.S.A.: http://www.brentanofabrics.com/fabrics_FAQ/nanotex.aspx), or the like. Wearable electronic materials may be used to construct the accessory and configured to contain electronic components (e.g. antenna array) and/or sensors that detect bio feedback like heart rate, oxygen level, body chemistry or the like. Further, the wearable electronic material of the accessory according to the disclosure may be interfaced to the electronic components of the wearable electronic device to add or otherwise enhance functionality.

In addition, the material of the wearable accessory 202 may be chosen based on functionality concerns, i.e., a material that assists in the stabilization of the support structure 102 may be chosen. For example, a material that has a capability for maintaining a knot formation may be chosen.

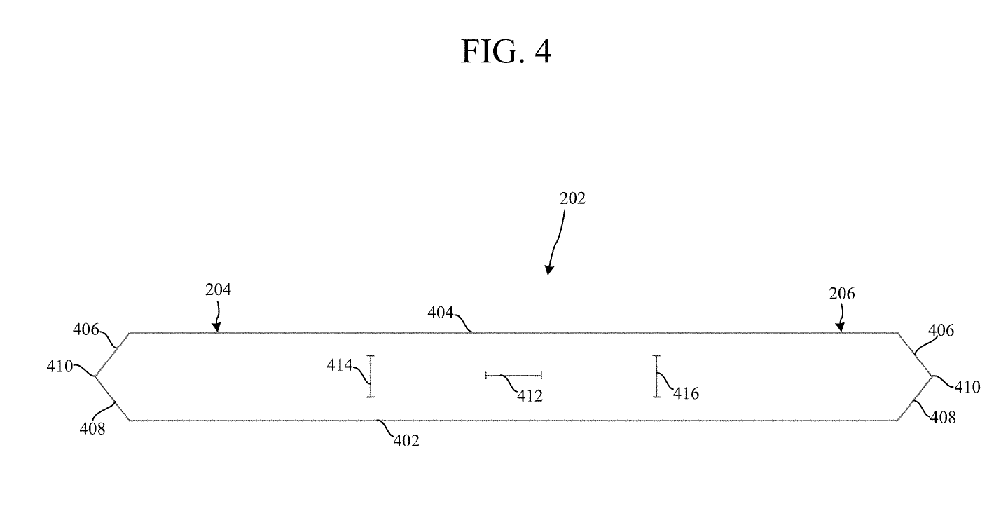

FIG. 4 illustrates a first side of the wearable accessory 202 separated from the wearable device 100. The wearable accessory 202 includes a first side edge 402 and a second side edge 404. The first and second side edges 402, 404 may be parallel or substantially parallel. Moreover, the first and second side edges 402, 404 may have equal lengths or different lengths. Each of the first side edge 402 and the second side edge 404 may extend along, e.g., parallel to, a length of the wearable accessory 202.

Each end portion 204, 206 of the wearable accessory 202 may be formed of a first end edge 406 and a second end edge 408 that meet at a point 410. The first end edge 406 and the second end edge 408 may be identical or substantially identical in length. For example, the first end edge 406 and the second end edge 408 may each extend about two (2) inches from an end of a side edge to the point 410. That is, the first end edge 406 and the second end edge 408 may each be about two (2) inches long.

The end portions 204, 206 of the wearable accessory 202 may have other configurations. For example, the end portions 204, 206 may be flat edges, i.e., each end portion may include a single end edge that extends orthogonally from an end of the first side edge 402 to a corresponding end of the second side edge 404. For further example, alternatively, each end portion may include a single curved or arcuate edge or wavy edge that extends from an end of the first side edge 402 to a corresponding end of the second side edge 404.

The end portions 204, 206 of the wearable accessory 202 may be identical. For example, each end portion may form a point, each end portion may be flat, each end portion may be curved, each end portion may be wavy, etc. Alternatively, the end portions 204, 206 may be different. For example, one end portion may form a point while the other end portion is planar. Other different configurations are also possible. Configuration of the end portions 204, 206 may depend upon style considerations, age of the user, geographic location of the user, as well as other considerations.

The wearable accessory 202 may include a first aperture 412 through which the wires 104, 110, or a portion of the support structure 102 to which the wires 104, 110 are coupled, extends. The first aperture 412 may be centrally located in the wearable accessory 202. That is, a middle point of the first aperture 412 may be located at a middle point of the length of the wearable accessory 202 as measured between the outer most points or edges of the wearable accessory 202, between ends of a single side edge 302, 304 of the wearable accessory 202. The middle point of the first aperture 412 may also or alternatively be located at a middle point of a width of the wearable accessory 202 as measured between corresponding portions or points of the first and second side edges 302, 304. The width of the wearable accessory 202 may vary depending upon considerations such as fashion, dimensions of the wearable device 100, etc. In an example, the wearable accessory 202 has a width of about two (2) inches when the wearable accessor 202 is in a planar configuration.

The first aperture 412 may provide a user access to a power supply of the wearable device 100. For example, the first aperture 412 may allow a user to replace batteries of the wearable device 100 without requiring the user remove the wearable device 100 from the wearable accessory 202. Alternatively, the first aperture 412 may provide a user access to a charging port of the wearable device 100, such that the user may couple a charging cord to the charging port without having to remove the wearable device 100 from the wearable accessory 202.

The first aperture 412 may be a slit, when the wearable accessory 202 is in a planar configuration (as illustrated in FIG. 4). The first aperture 412 may have a length equal to or substantially equal to a length of an end edge 306, 308 of the wearable accessory 202. For example, the first aperture 412 may have a length of about two (2) inches. The length of the first aperture 412 may extend along or parallel to the length of the wearable accessory 202. The length of the first aperture 412 may also extend along or parallel to one or both of the side edges 302, 304. It should also be appreciated that the first aperture 412 may extend along or parallel to the width of the wearable accessory, i.e., the first aperture 412 may perpendicularly or substantially perpendicularly extend between the side edges 302, 304 of the wearable accessory 202. The first aperture 412 may be positioned such that equal amounts of the wearable accessory 202 extend from a center or corresponding edges of the first aperture 412 in opposite directions. Alternatively, the first aperture may be configured in geometric shapes, such as a round, square, rectangular aperture or the like.

The wearable accessory 202 may further include a second aperture 414 and a third aperture 416. The second aperture 414 may allow a first end portion of the support structure 102 to extend from the wearable accessory 202, and the third aperture 416 may allow a second end portion of the support structure 102 to extend from the wearable accessory 202. The second aperture 414 may also allow the speaker 112 and corresponding wire 110 to extend from the wearable accessory 202, and the third aperture 416 may allow the speaker 105, microphone 108, and corresponding wire 104 to extend from the wearable accessory 202.

A distance between the second aperture 414 and the third aperture 416 may be configurable based on the size of the wearable device 100, or a portion of the wearable device 100 such as the support structure 102. The distance between the second aperture 414 and the third aperture 416 may further be configurable based on an amount of the wearable device 110, or a portion of the wearable device 100 such as the support structure 102, to be extended from the wearable accessory 202. In an example, the distance between the second aperture 414 and the third aperture 416 is about ten and one-quarter (10¼) inches. A midpoint of the distance between the second aperture 414 and the third aperture 416 may be located at or substantially at a midpoint of the length of the wearable accessory 202, as measured between outer most points of the wearable accessory 202, ends of a single side edge 302, 304 of the wearable accessory 202, etc. A midpoint of the distance between the second aperture 414 and the third aperture 414 may also or alternatively be located at or substantially at a midpoint of the first aperture 412. In an illustrative implementation, the second and third apertures 414, 416 are positioned such that equal amounts of the end portions 204, 206 extend from the second and third apertures 414, 416, respectively.

One or both of the second aperture 414 and third aperture 416 may be a slit (of vertical or horizontal configuration in relation to the length of the accessory), when the wearable accessory 202 is in a planar configuration (as illustrated in FIG. 4). A length of the second aperture 414 may be equal to a length of the third aperture 416, or the lengths of the second aperture 414 and the third aperture 416 may be different. The lengths of the second and third apertures 414, 416 are configurable based on a width of the wearable accessory 402, i.e., a distance between corresponding locations of the side edges 302, 304. Moreover, the lengths of the second and third apertures 414, 416 are configurable based on characteristics (e.g., diameter, radius, circumference, cross-section, etc.) of the wearable device 100 or a portion of the wearable device 100 such as the support structure 102. In an example, the second aperture 414 and the third aperture 416 are each one and one-half (1½) inches long. Alternatively, the aperture(s) may be configured in geometric shapes, such as round, square, rectangular aperture or the like.

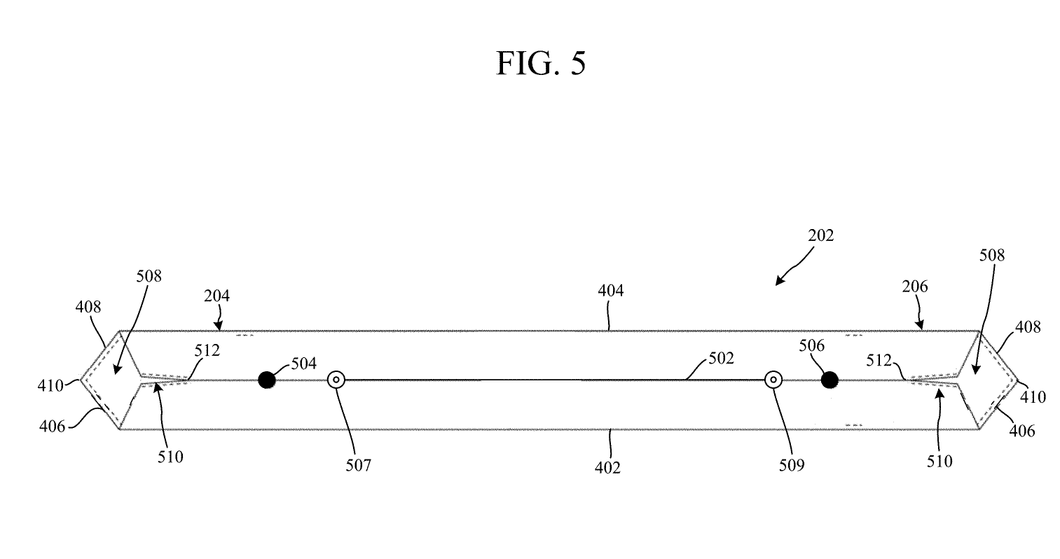

FIG. 5 illustrates a second side of the wearable accessory 202 (opposite the first side of the wearable accessory 202 illustrated in FIG. 4) without the wearable device 100 located therein. The wearable accessory 202 may include a seam 502 that extends along or is parallel to the length of the wearable accessory 202. The seam 502 may be a location where edges of the wearable accessory's material are brought together for assembly. The seam 502 may be coupled by seam couplings, such as a first stitch 504 and a second stitch 506. One or more of the first and second stitches 504, 506 may couple or fasten the edges of the wearable accessory's material to a portion of the wearable accessory's material illustrated in FIG. 4. The first and second stitches 504, 506 may couple to an exterior portion of the wearable accessory 202 as well as an interior portion of the wearable accessory 202, i.e., the first and second stitches 504, 506 may be visible from a first view (illustrated in FIG. 5) but not a second view (illustrated in FIG. 4). Alternatively, the first and second stitches 504, 506 may couple to two exterior portions of the wearable accessory 202, i.e., the first and second stitches 504, 506 may be visible from both a first view (illustrated in FIG. 5) and a second view (illustrated in FIG. 4). The stitches 504, 506 may have various shapes and sizes and in an alternative embodiment the stitches may run the entire length holding together the edges. In an example, the stitches 504, 506 are circular and have radii of one-half (½) an inch. An outer edge of a stitch may be about one-half (½) inches away from an edge of either the second aperture 414 or the third aperture 416 along the length of the wearable accessory 202. Other seam couplings may be used to join the edges in addition or alternatively to the stitches, such as buttons, clasps, zippers, hooks, hook and pile or the like.

In addition to the seam couplings or stitches, the wearable accessory 202 may include fasteners for fastening the two ends of the accessory together, as an alternative (or in addition to) tying the ends together to stabilize and secure the accessory 202 in place on the wearer. The fasteners, 507 and 509 illustrated in FIG. 4, may include snaps, buttons, hook and pile, or in some cases magnets positioned on the side of the accessory (or opposite the first side of the wearable accessory 202 illustrated in FIG. 4).

The seam 502 may remain uncoupled at locations other than at the stitches 504, 506. That is, the stitches 504, 506 may be the only locations where the seam 502 is coupled. As such, each end portion 204, 206 of the wearable accessory 202 may include an opening 508 where material of the wearable accessory 202 is unfastened/uncoupled. Each opening 508 may have an elongated portion 510 extending away from the point 410 of the wearable accessory 202 forming part of the corresponding opening 508. In an example, the elongated portion 510 includes two sides that converge on a point 512. The point 512 may be a location of the opening 508 most distance from, i.e., distal, the point 410 forming part of the opening 508. In an example, each side of the elongate portion 510 is about one and one-half (1½) inches long.

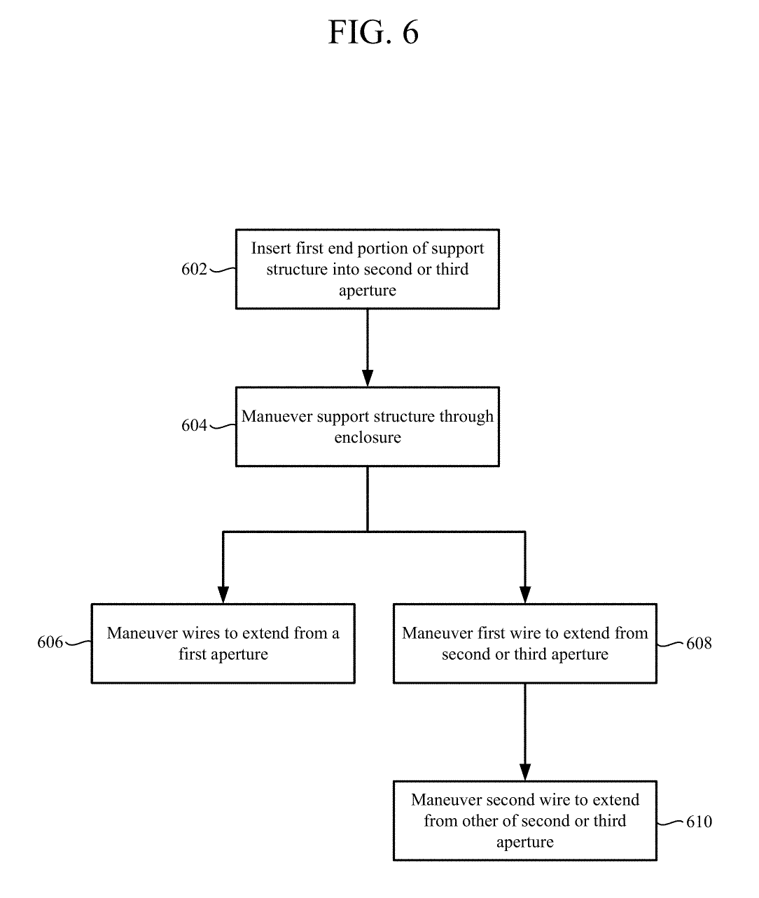

FIG. 6 illustrates a method for inserting the wearable device 100 into the wearable accessory 202. A first end portion of the support structure 102 is inserted (602) into one of the second aperture 414 or the third aperture 416. The support structure 102 is then maneuvered (604), e.g. slid, through an enclosure of the wearable accessory 202 until a desired amount of the end portions of the support structure 102 extend from the second and third apertures 414, 416, respectively. The wires 104, 110 are also maneuvered (606) to extend from the first aperture 412. For example, a portion of the support structure 102 coupled to the wires 104, 110 may be maneuvered to extend from the first aperture 412. Alternatively, the first wire 104 may be maneuvered (608) to extend from one of the second or third apertures 414, 416, and the second wire 110 may be maneuvered (610) to extend from the other of the second or third apertures 414, 416.

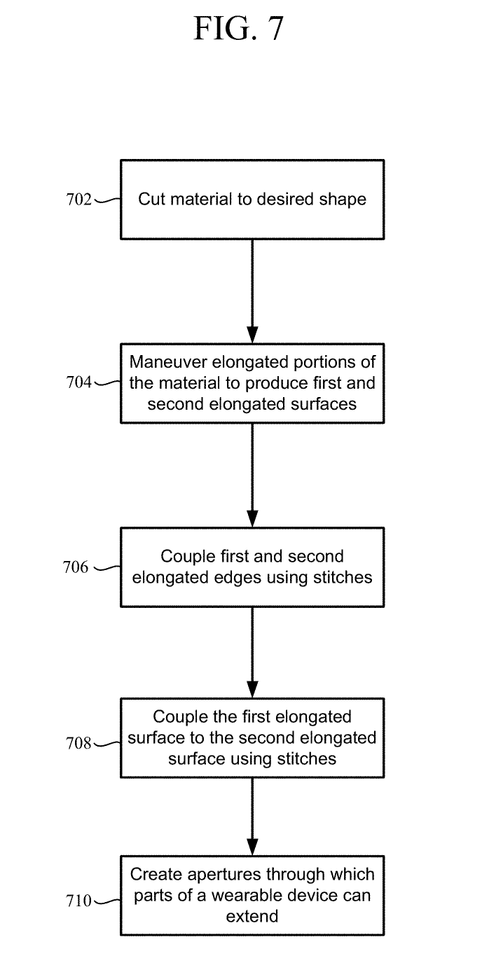

FIG. 7 illustrates a method for making the wearable accessory 202. A material may be cut (702) to produce a wearable accessory 202 of a desired shape. Two elongated portions of the material may then be maneuvered (704) to configure the material to have a first elongated surface and a second elongated surface. That is, the two elongated portions of the material are maneuvered to create an elongated channel or pocket. The first elongated surface may be parallel to and oppose the second elongated surface. Such maneuvering of the two elongated portions may involve bringing the two elongate surfaces into contact with or proximate each other. The first and second elongated edges may be coupled (706) together using two stitches. The first and second elongated edges forming part of the first elongated surface may also or alternatively be coupled (708), e.g., using the two stitches, to the second elongated surface. For example, the stitches may couple the first elongated surface to an interior or exterior face of the second elongated surface. Apertures through which parts of the wearable device can extend are also created (710).

In an alternative embodiment, the wearable fabric accessory may comprise a piece of fabric that can be used as a bandanna, a scarf, a tie, that can be worn around the neck, or head or torso, with one or more openings, specifically designed as an accessory or a single unit to thread an electronic device, such as a wearable neckband with headphones, there-through.

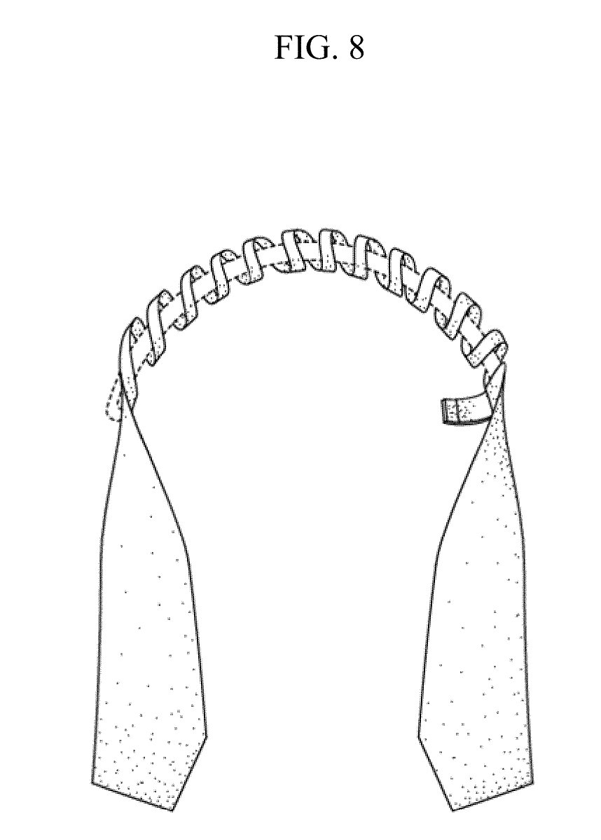

Alternatively, as illustrated in FIG. 8, the wearable fabric accessory may have only a single opening or aperture, as described herein, that a portion of the wearable device may be pushed and/or extend through. The wearable fabric accessory can be fastened into place at or near an end of the wearable electronic device, and the accessory may be of a length such that an electronic device can be wrapped with it. That is, in an embodiment where the wearable accessory 202 is configured with a single aperture, the accessory may be configured as a wrap and is of a length sufficient to wrap all or a substantial portion of the wearable electronic device. The fabric of the wearable accessory 202 can be wrapped around the support structure, effectively enclosing the support structure within the fabric. Hook and pile, buttons, snaps, clips or the like can be used to create and maintain a tube or pocket for the wearable electronic device to fit through.

A wrap embodiment as illustrated in FIG. 8 may be similarly implemented using a pattern such as illustrated in FIG. 5. Such an embodiment could be split open along the seam in the middle, to create one piece of fabric to be placed around the support structure of the wearable electronic device enclosing the support structure. A plurality of closure mechanisms, such as at least one of snaps, buttons, hook and pile or the like, can be disposed along the seam from the first end portion to the second end portion and configured to be fastened together using the at least one of snaps, buttons, hook and pile to close the wrap forming a channel via the closure mechanisms being closed/fastened back along the seam.

The opening(s) or aperture(s) of the accessory described herein are meant to accommodate not only the insertion of the main electronics but for other components such as earbuds, extension cords for audio or power, to come in/out of the accessory. In some cases, the entire wearable electronic device can be hidden from view from the outside, for example the device may include microphones and speakers that are worn around the neck inside the fabric that are used as a music and calling device with earbuds that may be optional.

The wearable fabric electronic device according to the disclosure allows for easy insertion and removal of electronics from the garment/accessory, so that the garment/accessory can be washed, or changed to accessorize the color or fashion that is being worn by the user. The accessory is functional to secure the wearable electronic device around the body so that it is stable during active movements. It is hygienic and can absorb perspiration and be easily washed and changed, and it can be fashionable to adapt to different fabric types, colors, or patterns.

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A wearable electronic device accessory, comprising:
fabric formed as one of a scarf, bandana or necktie that is configured to surround all or part of an electronic support structure of a wearable electronic device, wherein the fabric is configured to be secured to part of or all of, the wearable electronic device.

2. The wearable electronic device accessory of claim 1 wherein the fabric is made of at least one of materials, including cotton, silk, nylon, nano technology based fabric that is anti-odor and antibacterial.

3. The wearable electronic device accessory of claim 1 in the form factor of one of a scarf, a bandanna, a neck tie.

4. The wearable electronic device accessory of claim 1, comprising
an elongated pocket having a first end and a second end, a first aperture located between the first end and the second end, a second aperture located proximate to the first end, and a third aperture located proximate to the second end,
wherein the elongated pocket surrounds at least a portion of a support structure of the wearable device,
wherein at least on wire of the wearable device extends through the first aperture,
wherein a first end portion of the support structure extends through the second aperture,
wherein a second end portion of the support structure extends through the third aperture.

5. The wearable electronic device accessory of claim 1, further comprising a first end portion and a second end portion, the first end portion and the second end portion stabilizing the support structure when the first end portion and the second end portion are fastened together.

6. The wearable electronic device accessory of claim 1, comprising a first end portion and a second end portion configured to be fastened together using at least one of snaps, buttons, hook and pile and tying.

7. The wearable electronic device accessory of claim 1, comprising a first end portion and a second end portion wherein the first end portion includes the at least one aperture and the fabric of the wearable electronic device accessory is configured to be wrapped around the wearable electronic device and secured at the second end portion.

8. The wearable electronic device accessory of claim 1, having an elongated pocket that includes a first side edge and a second side edge, the first side edge and the second side edge being substantially parallel.

9. The wearable electronic device accessory of claim 1, wherein the at least one aperture is at least one of substantially centrally located along a length of the wearable accessory, proximate a first end and proximate a second end.

10. The wearable electronic device accessory of claim 1, wherein a middle point of the at least one aperture is substantially centrally located along a width of the wearable electronic device accessory, and wherein equal amounts of the wearable electronic device accessory extend from corresponding edges of the at least one aperture in opposite directions.

11. The wearable electronic device accessory of claim 1, further including a second aperture and a third aperture separated by a distance, and wherein the midpoint of the distance is centrally located alone a length of the wearable electronic device accessory.

12. A method of using a wearable accessory in conjunction with a wearable device, comprising:
inserting a first end portion of a support structure of the wearable device into at least one aperture of the wearable accessory; and
maneuvering the support structure through an enclosure of the wearable accessory until a desired amount of the first end portion extends from the wearable accessory and a second end portion of the support structure extends from the wearable accessory.

13. The method of claim 12, further comprising:
fastening together a first end and a second end of the wearable accessory using at least one of snaps, buttons, hook and pile and tying.

14. The method of claim 12, further comprising:
forming an elongated pocket having a first end and a second end, the first aperture located between the first end and the second end, wherein the elongated pocket surrounds at least a portion of a support structure of the wearable device.

15. The method of claim 12, further comprising:
stabilizing the support structure when the first end portion and the second end portion are fastened together.

16. A method of making a wearable accessory that at least partially surrounds a wearable device, comprising:
cutting a material to a desired shape, the desired shape including a first elongated portion and a second elongated portion;
creating an elongated channel having a first elongated surface and a second elongated surface by opposing the first elongated portion to the second elongate portion, the first elongated surface opposing the second elongated surface, the first elongated portion and the second elongated portion forming the first elongated surface;
coupling the first elongated surface and the second elongated surface to form an elongated channel; and
creating at least one aperture in the elongated channel, the at least one aperture allowing an end portion of a wearable device to extend therethrough.

17. The method of claim 16, wherein the at least one aperture includes:
a first aperture through which at least one wire of the wearable device extends;
a second aperture through which a first end portion of a support structure of the wearable device extends; and
a third aperture through which a second end portion of the support device extends.

18. The method of claim 16, wherein coupling the first elongated surface and the second elongated surface to form an elongated channel involves using at least one seam coupling, the at least one seam coupling being one of a stitch, buttons, clasps, zippers, hooks, and hook and pile.
